(19) United States
(12) Patent Application Publication
(10) Pub. No.: US 2017/0139849 A1
(43) Pub. Date: May 18, 2017

(54) DRIVERLESS STORAGE DEVICE USING SERIALLY-ATTACHED NON-VOLATILE MEMORY

(71) Applicant: HGST Netherlands B.V., Amsterdam (NL)

(72) Inventors: Zvonimir Z. BANDIC, San Jose, CA (US); Martin LUEKER-BODEN, San Jose, CA (US); Dejan VUCINIC, San Jose, CA (US); Qingbo WANG, Irvine, CA (US)

(73) Assignee: HGST Netherlands B.V.

(21) Appl. No.: 14/943,925

(22) Filed: Nov. 17, 2015

(51) Int. Cl. G06F 13/16; G06F 13/42

(52) U.S. Cl. CPC G06F 13/1668; G06F 13/4282

(57) ABSTRACT

A method and system for accessing a driverless storage device via a byte-addressable protocol. Properly leveraging real-time queue polling between a CPU and Non-Volatile Memory (“NVM”) requires significant, complex, customized software and elaborate device drivers that consume operating systems. The present system maximizes existing host operating systems and memory management hardware and makes the NVM appear as simple memory to a CPU, reducing submission and completion latency and increasing effective bandwidth utilization. In one embodiment, a fast serial protocol translates storage in a target into a byte-addressable memory aperture. The fast serial protocol exposes byte-addressable memory aperture to a memory address range in a host. The host, in communication with a controller, sends a single request for data and receives, from the controller in communication with the storage medium, the data. The communication protocol runs through an intermediate controller that performs error checking, buffers incoming commands, etc.

### BACKGROUND OF THE DISCLOSURE

Field of the Disclosure

Embodiments of the present disclosure generally relate to methods and systems for performing operations in a communication protocol between a processor and memory device.

Description of the Related Art

A system's memory can be composed of primary storage, secondary storage, tertiary storage, and at times off-line storage, with its own cache hierarchy of speed and accessibility. Communication between a storage media and the processing unit of a computer is defined by both the command set/protocols specifying instructions for read/write and the register programming interface upon which those commands are transmitted. Industry participants have collectively defined this to be a communication protocol in order to enable faster adoption and interoperability of storage media connected to a host over a peripheral computer expansion bus.

Primary storage is the only type directly accessible to the central processing unit (CPU). The CPU connects to the main type of primary storage, DRAM, through a memory composed of two units, the data bus and address bus. The address bus specifies the desired location of data and the data bus reads or writes data via the data bus. To access secondary storage, the CPU retrieves data from a memory storage device through direct communication via input/output (I/O) channels and I/O controllers that sit in-between the CPU and the storage device.

When secondary storage primarily consisted of slow mechanical hard disk drives, the entire fetch/execute cycle took several milliseconds to complete. However, emerging memory technology, for storing information for use in computers today, fetches data within 100 nanoseconds. Of those technologies, non-volatile memory (NVM) has gained interest for its ability to retain stored data without requiring power. Examples of low-latency non-volatile memory may include read-only memory (ROM), magnetoresistive random access memory (MRAM), Resistive random access memory (ReRAM), phase change random access memory (PCM), and flash memory, such as NOR and NAND flash, etc. With the improved storage devices reducing the data fetch time to nanoseconds, the microseconds it takes for each communication between the CPU and secondary storage adds significant amount of time to the data fetch/execute cycle time.

Therefore, there is a need in the art for an improved communication protocol to reduce the data fetch/execute cycle time.

### SUMMARY OF THE DISCLOSURE

The present disclosure generally is a method and system for accessing a driverless storage device via a byte-addressable memory aperture. Properly leveraging real-time queue polling between a CPU and Non-Volatile Memory (“NVM”) requires significant, complex, customized software and elaborate device drivers that consume operating systems. In one embodiment, a fast serial protocol translates storage in a target into a byte addressable memory aperture. The fast serial protocol exposes the byte addressable memory aperture to a memory address space in a host. The host, in communication with a controller, sends a single request for previously stored data and receives, from the controller in communication with the storage, the previously stored data. The communication protocol runs through an intermediate controller that performs error checking, buffers incoming commands, etc. The present system utilizes host operating systems and makes the NVM appear as simple memory to a CPU, reducing submission and completion latency and increasing effective bandwidth utilization.

In one embodiment, a method for accessing a driverless storage device via byte addressable memory apertures includes: a fast serial protocol translating storage medium in a target device into a byte addressable memory apertures, having the fast serial protocol expose the byte addressable memory apertures to a memory address space in a host over an interface, configuring the byte addressable memory apertures into the memory address space in a host, sending from the host—in communication with the controller—a request for previously stored data, and receiving—from the controller in communication with the storage in the target—the data.

In another embodiment, a computer system for performing operations in accessing a driverless storage device via a byte addressable memory apertures is disclosed. The computer system for accessing a driverless storage device via a byte addressable memory apertures includes: memory in communication with a host, storage media in communication with a target, and a controller in communication with the host and the target via a fast serial protocol. The storage medium stores and retrieves data. The fast serial protocol translates the storage in the target device into a byte addressable memory apertures, and exposes the byte addressable memory apertures to a memory in the host, where the host configures the byte addressable memory apertures into the memory address space. The fast serial protocol logic relays a request for data from the host, checks the request in the controller, sends the request for data to the target, relays the data from the target, checks the data in the controller, and sends the host the data.

In another embodiment, a non-transitory computer-readable medium, storing instruction that, when executed by a processor, cause a computer system to perform operations for accessing a driverless storage device via a byte addressable memory apertures. The steps performed include: having a logical hardware controller initiate communication using a fast serial protocol, translating a storage in a target device into a byte addressable memory aperture, exposing the byte addressable memory apertures to a memory address space in a host, configuring the byte addressable memory apertures into the memory in the host, sending—from the host to the controller—a request for data to be read or data to be written, and receiving—from the controller in communication with the storage in the target—the data requested.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A shows a schematic representation of a system accessing a driverless storage device via byte addressable memory aperture, according to one embodiment.

FIG. 1B shows a schematic representation of a block diagram with byte addressable memory apertures as translated from a storage device to a host, according to one embodiment.

FIG. 2 shows a schematic representation of a host utilizing the byte addressable memory apertures to access memory on a storage device, according to one embodiment.

FIG. 3 shows a schematic representation of a block diagram communication utilizing fast serial links, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure is a method and system for accessing a driverless storage device via a byte-addressable protocol. Properly leveraging real-time queue polling between a CPU and Non-Volatile Memory (“NVM”) requires significant, complex, customized software and elaborate device drivers that consume operating systems. In one embodiment, a fast serial protocol translates storage in a target into a byte-addressable memory aperture. The fast serial protocol exposes the byte-addressable memory aperture to a memory address space in a host. The byte-addressable protocol is configured into the memory. Specifically, the fast serial protocol memory maps the byte-addressable memory aperture to a memory address space on the host. The present disclosure maximizes the use of existing memory management hardware in modern computer systems. The host, in communication with a controller, sends a single request for data and receives, from the controller in communication with the storage, the data. The communication protocol runs through an intermediate controller that performs command queueing, error checking or error correction, buffers incoming commands, maintains the health of the underlying storage media etc. The present system utilizes host operating systems and hardware memory controllers and makes the NVM appear as simple memory to a CPU, reducing submission and completion latency and increasing effective bandwidth utilization.

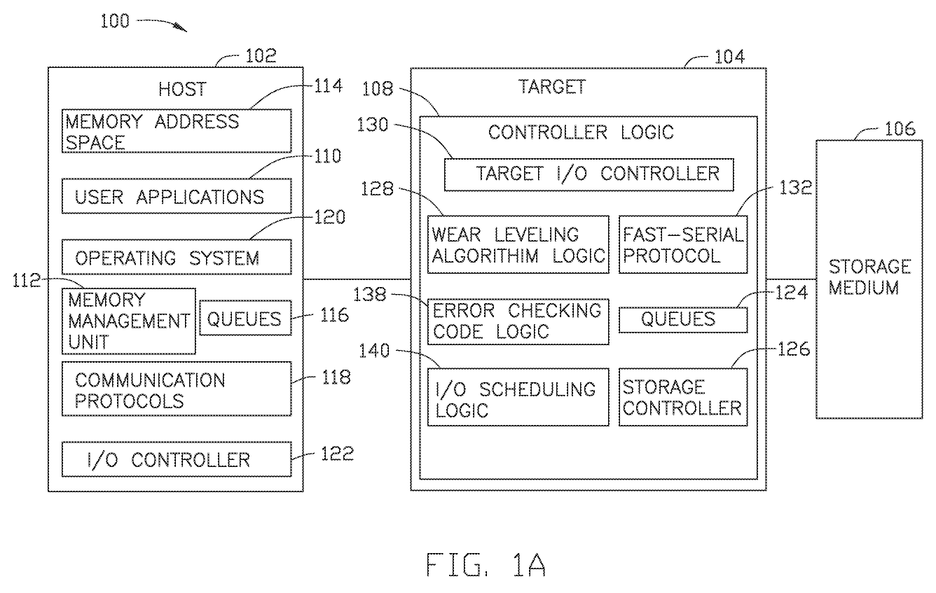

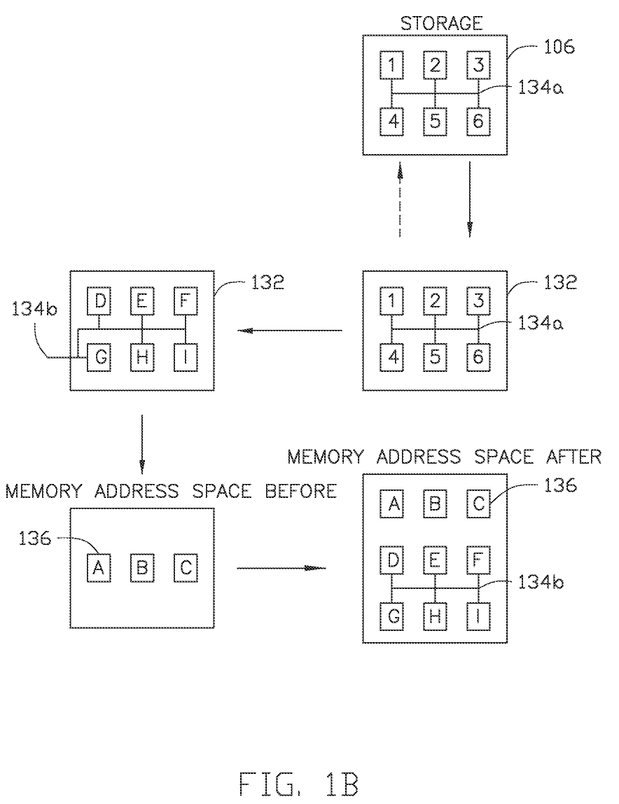

FIG. 1A shows a schematic representation of a system accessing a driverless storage device via a byte addressable memory aperture, according to one embodiment. The system 100 includes a host 102 in communication with a target device 104 and storage 106. The host 102 includes user applications 110, memory management unit (MMU) 112, memory address space 114, queues 116, communication protocol 118, operating system 120, and I/O controller 122. The target device 104 includes controller logic 108. The controller logic 108 includes target queues 124, storage controller 126 in communication with storage 106, target I/O controller 130, fast-serial protocol 132, error checking code logic 138, I/O scheduling logic 140 and a wear leveling algorithm logic 128. In some embodiments the controller logic 108 may be a high speed interface such as peripheral component interconnect express (PCIe), although other packet-based links may be utilized.

Depending on the embodiment chosen, there may be several different command queues each embodied in potentially unique ways. In some embodiments, a command queue 116 may be a hardware entity located between the host 102 CPU and the I/O memory management unit 112. In some embodiments these hardware queues 116 may be very deep (have a very large capacity) to allow for large numbers of asynchronous requests. In other embodiments this hardware queue 116 may be very simple, allowing only for instantaneous processing of commands. In such embodiments where a command queue 116 is a hardware entity between the host 102 CPU and the MMU 112, the process of enqueuing of command typically consists of a single CPU instruction. In other embodiments, such as when the fast serial protocol 132 is related to remote direct memory access (RDMA) memory transfers, such as Infiniband, iWARP and RDMA over Converged Ethernet or RoCE, a command queue 116 may take the form of a memory-based data structure. For example, command queues 116 may be the Send Queue (SQ) half of an RDMA Queue Pair. In such embodiments, these data structures may be managed either by software on the host 102, or by logical hardware embedded in the RDMA-capable host network adaptor. In yet further embodiments, such when the communication protocol 118 uses flow control mechanisms similar to those used by Peripheral Component Interconnect Express (PCIe), a command queue 116 may also take the form of structures within the logical controllers associated with the communication protocols 118. In such embodiments the organization of these queues may be chosen to adhere to the Data Link Layer (DLL) rules established by that protocol in order to promote robust communication between the target 104 and the host 102.

The host 102 may be a processor such as a central processing unit (CPU). The host 102 can run user-level applications 110 on operating system 120. In one embodiment, the host 102 includes a memory management unit 112 also known as a memory controller. The memory controller 112, functioning as an I/O controller, generates a memory write/read packet for transmission over the fast-serial protocol 132. Communication protocol 118 can map devices to memory address space 114. For instance, in embodiments where protocol 118 is chosen as the peripheral component interface (PCI) or any one of its derivatives, devices can be mapped to memory address space 114 via a base address range. In some embodiments, segments of the host memory address space 114 can be mapped to dynamic random access memory (DRAM). Host memory management unit 112 can use queues 116 to store commands from host 102 for target 104 to process. Stored or enqueued commands can include read or write operations from the host 102, as well as prefetch operations for speculative reads or fence operations for enforcing strict ordering of queue operations.

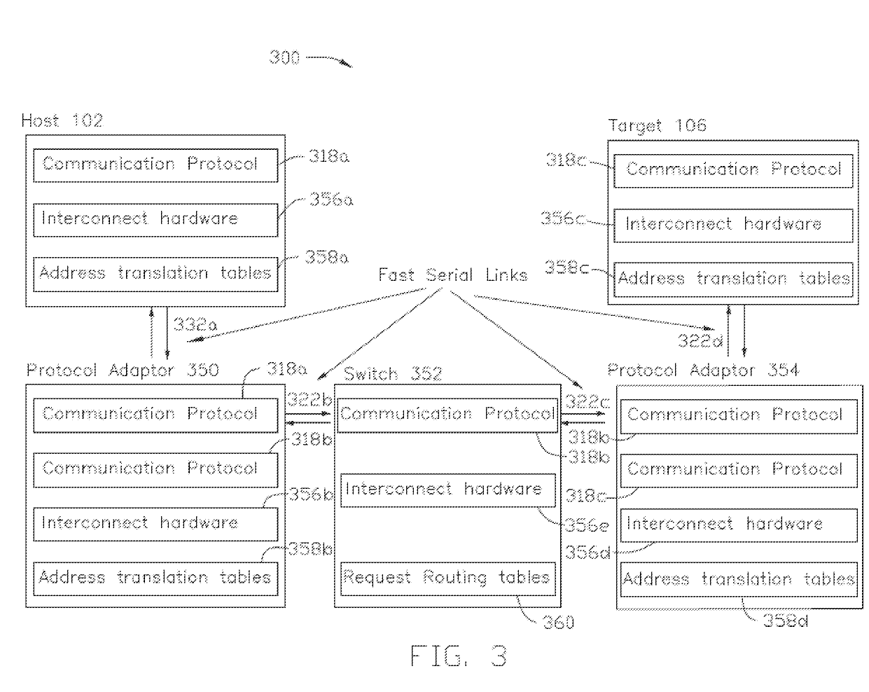

Communications protocol 118 can allow host 102 to communicate with target device 104 after passing through target I/O controller 130 via fast serial protocol 132. In some embodiments I/O controller 130 is an intermediate logic that performs error checking using the error checking code logic 138, failure detection, wear leveling using the wear leveling algorithm logic 128, verifying-within the controller-the integrity of the data, or correcting-within the controller-any errors due to non-ideal behavior of the storage media. In another embodiment target controller 130 buffers incoming writes. In some embodiments the communication protocol 118 may be transferred over a fast serial protocol 132 such as peripheral component interconnect express (PCIe), although other packet-based links may be utilized. In another embodiment the fast serial protocol 132 may be a networking protocol such as Ethernet, serial attached SCSI (SAS), or serial AT attachment (SATA). In another embodiment, the fast serial protocol 132 may also be any protocol related to remote direct memory access (RDMA) such as Infiniband, iWARP, or RDMA over Converged Ethernet (RoCE). In some embodiments, communication between the host 102 and the target 104 may pass through several electrical links, as shown in FIG. 3, each connected by an interconnect switch 350 or by a protocol bridge adaptor 352. In such embodiments communication along each link may be negotiated according to a different protocol. For instance, a request placed in command queue 116 may be routed through a PCIe root port, switch to an Infiniband link via a network adaptor, and then switch back to PCIe before arriving at the target device 104.

The target device 104 can communicate with host 102 via the controller 130 and communication protocol 128. Communication protocol 128 can provide queues 124 to access storage 106 via storage controller 126. In some embodiments the target device 104 may be a non-volatile memory such as phase-change memory (PCM), magnetoresistive random access memory (MRAM), resistive random access memory (RRAM or ReRAM), ferroelectric random access memory (F-RAM), or other types of non-volatile memory.

The non-volatile memory technologies used in different embodiments of this invention will all possess unique strengths and weaknesses. Each may require different data processing techniques to preserve longevity of the storage media devices 106, accurate reproduction of data stored in the media 106, timing and scheduling of read or write commands, and detection of failures of individual storage media devices 106 within embodiments of the invention. As such, it becomes advantageous to have a controller that hides the idiosyncrasies of the emerging NVMs and make them appear as simple memory to the host CPU.

In FIG. 1B, byte addressable memory apertures are translated from a storage device to a host, according to one embodiment. The storage 106 contains memory space 134a. The memory space 134a is represented graphically by “1,” “2,” “3,” “4,” “5,” and “6” respectively. The storage device 106 is connected to and communicates with the fast serial protocol 132. The fast serial protocol 132 translates the memory space 134a in the storage 106 of a target device 104 into byte addressable memory apertures 134b. In some embodiments, the byte addressable memory apertures 134b are a memory Base Address Range (BAR). The byte addressable memory apertures are graphically represented by “A,” “B,” “C,” “D,” “E,” “F,” “G,” H,” and “I.” Memory apertures 136, labelled A B and C, in the memory address space 114 correspond to other memory devices in the larger system, such as dynamic random access memory (DRAM). The fast serial protocol exposes the byte addressable memory apertures 134b to the memory 114 of the host 102.

In one embodiment, the fast serial protocol 132 translates the memory space 134a by exposing a window into the full storage memory space as byte addressable memory apertures 134b. In another embodiment, the fast serial protocol 132 translates the memory space 134a by advertising byte addressable memory apertures 134b large enough to accommodate all the memory space 134a offered by the storage device 106. The byte addressable memory apertures 134b are configured into the memory 114 of the host 102. In one embodiment, the host 102 memory-maps the byte addressable memory apertures 134b in the memory 114.

For each memory aperture 134b, the memory map contains an address range within the memory address space 114, and the corresponding addresses in storage media 106. The memory map is passed on from the firmware in order to instruct command queues when command is processed. The memory 114 goes from having byte addressable memory apertures 136 to containing byte addressable memory apertures 136 and 134b. As such, the host 102 CPU in direct communication with the memory 114 can access the memory space 134a of the storage 106 using a single command instruction. In one embodiment the command instruction is a memory read (MemRd) transaction packet (TLP). In another embodiment the command instruction is a memory write TLP.

In one embodiment, the memory aperture 136, 134b can be accessed by a network via remote direct memory access (RDMA). The memory 114 of host 102 can be accessed by a second host without involving either host's operating systems. Since the memory space 134a of storage 106 in the target 104 corresponding to the byte addressable memory apertures 134b in the memory 114 is mapped into the memory 114 of the host 102 by the fast serial protocol 132, the memory space 134a can too be directly accessed by another host via RDMA. The second host maps the byte addressable memory apertures 134b and 136 from host 102 into its own memory and is then able to access memory space 134a. Thus, the storage 106 in the target 104 can be transmitted through remote direct non-volatile memory access (RDNVMA).

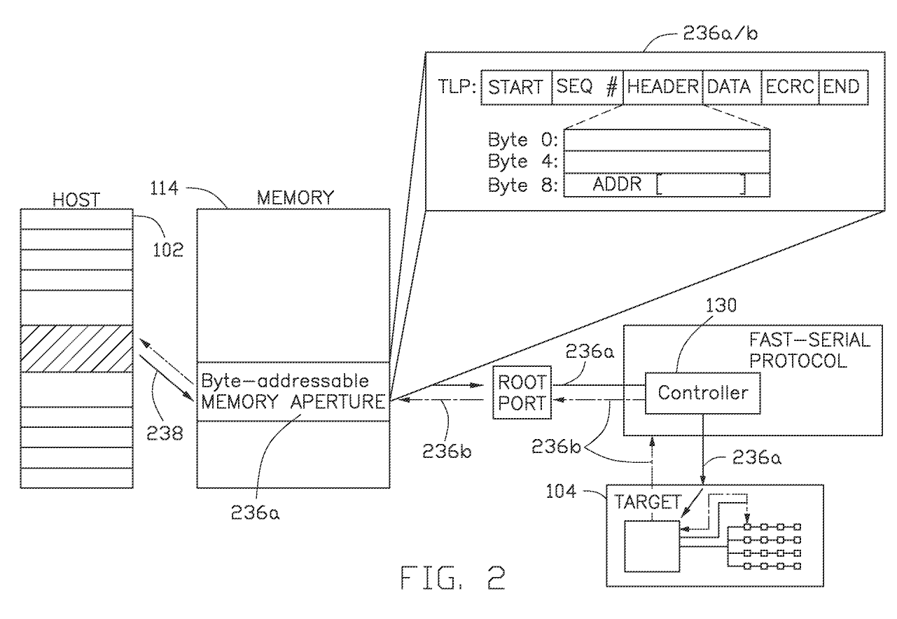

As way of example, FIG. 2 shows a schematic representation of a host utilizing the byte addressable memory apertures to access memory on a storage device, according to one embodiment. It should be understood FIG. 2 describes an embodiment utilizing PCIe and is meant for example purposes only. Several other fast serial protocols may be utilized with the present disclosure including: Ethernet, serial attached SCSI (SAS), serial AT attachment (SATA), any protocol related to remote direct memory access (RDMA) such as Infiniband, iWARP, or RDMA over Converged Ethernet (RoCE), etc. The host 102 sends an enqueue command 238 to the memory 114. In one embodiment, the enqueue 238 is a memory write packet for transmission over the fast serial protocol 132. In another embodiment the enqueue 238 is a memory read packet for transmission over the fast serial protocol 132. The host memory 114 can access the mapped byte addressable memory apertures 236a. It should be understood that the byte addressable memory apertures 236a can be the same byte addressable memory apertures 134b shown in FIG. 1. In one embodiment, the byte addressable memory apertures 236a can include a TLP size of 32-bit addressing and three or four 32-bit words (2 DWs, Double Words). In another embodiment, the byte addressable memory apertures 236a can include a TLP size of 128-bit words, 256-bit words, or 512-bit words.

The TLP includes a Data Link layer responsible for making sure that every TLP arrives to its destination correctly and is wrapped with its own header and Link CRC, transaction layer—that includes a header layer, data layer, and ECRC layer, and physical layer that indicates the start and stop of the TLP. The TLP header in the transaction layer includes an Fmt field, Type field, TC field, TD field, CRC—such as ECRC and LCRC, Length field, Requester ID field, Tag field, 1st Double-Word Byte (BE) field, Last BE field, and Address field. It can be imagined that the TLP can include more fields in the physical layer, data link layer, or the transaction layer. The address field specifies that the information being sought either read or write is located on in the storage 106 of the target 104. A byte addressable memory apertures 236a is transmitted through the fast serial protocol 132 on controller logic 108, the controller 130 buffers the incoming byte addressable memory apertures 236a to check for errors before the byte addressable memory apertures 236a proceeds to the target 104. The storage controller 126 uses the byte addressable memory apertures 236a to retrieve the data at the specific location specified. The target 104 then returns the data via the byte addressable memory apertures 236b through the controller 130. In one embodiment, as the byte addressable memory apertures 236b passes through the controller 130, the controller 130 performs cyclic redundancy checks or error-checking to detect any accidental changes in the raw data. The byte addressable memory apertures 236b returns to the host 102 via the memory 114.

FIG. 3 shows a schematic representations of a block diagram communication 300 utilizing fast serial links, according to one embodiment. The communication 300 includes host 102, protocol adaptor 350, protocol adaptor 354, switch 352, target 106, and fast serial links 332a, 332b, 332c, and 332d. It may be understood that the communication 300 may be utilized so that a host 102 may access memory on a storage device through different communication protocols. The communication between the host 102 and the controller is mediated by several communication links, each subject to a fast serial protocol. It may be understood that the communication protocols, 318a, 318b, 318c, etc. may be one or more fast serial protocols such as PCI Express (PCIe), SAS, SATA, Infiniband, or Ethernet. In embodiments that may utilize Ethernet, the communication may also include an additional RDMA protocol such as iWARP or RD\MA over Converged Ethernet (RoCE). In embodiments where the link between host 102 and the target 106 requires a sequence of several communication protocols (e.g. 318a, 318b, 318c, etc.) to establish a connection, each protocol bridge adaptor may contain an additional memory maps which provide further instruction on how to process each request. As a way of example, FIG. 3 shows three communication protocols, but it may be imagined that more communication protocols may contained in the link between the host 102 and the target 106. The logical hardware controller initiates communication using a fast serial protocol, translates a storage in a target device into a byte addressable memory aperture in turn is access to the underlying storage medium, accesses or places data in the underlying storage medium, and maintains the health and reliability of the underlying storage medium through techniques including—but not limited to—memory wear levelling, data error checking codes (ECC), and I/O scheduling algorithms. sends—from the host to the controller—a request for data to be read or data to be written.

In one embodiment, the host 102 and the target 106 utilize different communication protocols. For example, the host 102 may use communication protocol 318a and the target 106 may use communication protocol 318c. The host 102 and the target 106 are connected via a fabric of interconnects which utilize protocol 318b. In one embodiment, the fabric of interconnects includes protocol adaptor 350, switch 352, and protocol adaptor 354. The fabric of interconnects are configured to enable the host 102 to utilize the memory space on the target 106 by translating the communication protocol 318a to the communication protocol 318c. The host 102 is in communication with the protocol adaptor 350 via fast serial link 332a. The protocol adaptor 350 translates communication protocol 318a to communication protocol 318b.

The protocol adaptor 350 is in communication with the switch 352 via a fast serial link 332b. The switch 352 routes requests from different locations. In one embodiment, the switch 352 may route a request from the host 102 via the protocol adaptor 350 to the target 106 via the protocol adaptor 354 using the request routing tables 360. The switch 352 is in communication with the protocol adaptor 354 via fast serial link 332c. The protocol adaptor may utilize interconnect hardware 356d to translate communication protocol 318b to communication protocol 318c. In one embodiment, the address translation tables 358a, 358b, 35bc, and 358d translate the addresses within protocol adaptor 350 and protocol adaptor 354 respectively. It may be understood that the addresses within the communication 300 may be the memory address space or byte addressable memory apertures of FIG. 1A and FIG. 1B respectively. The memory aperture exported by the controller through one communication link is further re-exported via each of the one or more fast serial protocols governing each link between the target controller and the host. The memory aperture is further remapped to all intervening memory address spaces between the target controller address space and the host memory address space.

In some embodiments, the byte addressable memory apertures in the target 106 may be expressed as different sets of addresses along the communication path from the target 106 to the protocol adaptor 354 to the switch 352 to the protocol adaptor 350 to the host 102. In some embodiments these addresses are a memory Base Address Range (BAR). The protocol adaptor 354 is in communication with the target 106 via a fast serial link 332d. The target 106 may include communication protocol 318c, interconnect hardware 356c, and address translation tables 358c. The target 106 may expose one address range via communication protocol 318c. However, this address range, or byte addressable memory aperture, may be known by a different set of addresses in the host 102. As such, an enqueued request is transmitted between a host 102 and a target 106 via the fast serial links 332a, 332b, 332c, and 332d through protocol adaptor 350, switch 352, and protocol adaptor 354 and is translated from one module to the next. As way of example, protocol adaptor 350 translates communication protocol 318a, utilized by the host, to communication protocol 318b so that the enqueue may be transmitted to protocol adaptor 354 through switch 352 and then translated by protocol adaptor 354 to communication protocol 318c utilized by the target.

Properly leveraging real-time queue polling between a CPU and NVM requires significant, complex, customized software and elaborate device drivers that consume operating systems. The present system utilizes host operating systems and makes the NVM appear as simple memory to a CPU. The communication protocol can be run through an intermediate controller that performs error checking, buffers incoming write commands, and performs wear leveling. The system, performed on any fast serial protocol, reduces submission and completion latency and increases effective bandwidth utilization.

While the foregoing is directed to embodiments of the present disclosure, other and further embodiments of the disclosure may be devised without departing from the basic scope thereof, and the scope thereof is determined by the claims that follow.

What is claimed is:

1. A method for accessing a driverless storage device via byte addressable memory apertures, the method comprising:
translating a storage medium in a target device into a byte addressable memory apertures, wherein the translation is done by a fast serial protocol, wherein the fast serial protocol comprises a controller;
exposing the byte addressable memory apertures to an address space in a host;
configuring the byte addressable memory apertures into the memory in the host;
sending, from the host in communication with the controller, a request for data; and
receiving, from the controller in communication with the storage medium in the target, the data.

2. The method of claim 1, wherein the controller performs wear leveling, command queueing, and error correction.

3. The method of claim 1, wherein the fast serial protocol is PCI Express (PCIe), SAS, SATA, Infiniband, or Ethernet.

4. The method of claim 1, wherein the byte addressable memory apertures utilizes a fast serial protocol specific interface layer.

5. The method of claim 1, further comprising sending, from the host in communication with the controller, one or more additional data requests.

6. The method of claim 1, wherein the host is a process.

7. The method of claim 1, wherein the memory-mapping the byte addressable memory apertures into the host is memory-mapped into a virtual address space of the host.

8. The method of claim 6, wherein the memory-mapping the byte addressable memory aperture into the host is memory-mapped into a virtual address space of the process.

9. The method of claim 1, further comprising sending from the host to the storage medium via the controller, an additional request to store additional data.

10. The method of claim 1, further comprising sending, from the host to the storage medium via the controller, a request for previously stored data.

11. The method of claim 1, further comprising sending, from the storage medium to the host via the controller, the previously stored data.

12. The method of claim 1, wherein the storage medium is a non-volatile memory device, wherein the non-volatile memory device is resistive random access memory (ReRAM), phase change random access memory (PCM), solid state drives (SSD), or magnetoresistive random access memory (MRAM).

13. A computer system for accessing a driverless storage device via byte addressable memory apertures, the system comprising:
memory in communication with a host;
storage, in communication with a target, for storing and retrieving requested data;
a controller in communication with the host and the target via a fast serial protocol, for transmitting requested data, the fast serial protocol configured to:
translate the storage medium in the target device into a byte addressable memory apertures;
expose the byte addressable memory apertures to a memory in a host, wherein the host configures the byte addressable memory apertures into the memory in the host;
receive from the host a request for data;
check the request in the controller;
send to the target the request for data;
receive from the storage medium the data;
check the data in the controller; and
send to the host the data.

14. The system of claim 13, wherein the host communicates with the controller via one or more fast serial protocols.

15. The system of claim 14, wherein the controller exports the memory aperture via the one or more fast serial protocols, and wherein the memory aperture is remapped to one or more intervening memory address spaces between the controller and the host.

16. The system of claim 15, wherein the memory aperture may utilize a network access via remote direct memory access (RDMA).

17. The system of claim 15, wherein the fast serial protocol is one or more of the following: PCI Express (PCIe), SAS, SATA, Infiniband or Ethernet.

18. A non-transitory computer-readable medium storing instructions that, when executed by a processor, cause a computer system to for accessing a driverless storage device via byte addressable memory apertures, by performing the steps of:
translating a storage in a target device into a byte addressable memory apertures, wherein the translation is done by a fast serial protocol, wherein the fast serial protocol comprises a controller;
exposing the byte addressable memory apertures to a memory address space in a host;
configuring the byte addressable memory apertures into the memory in the host;
sending, from the host in communication with the controller, a request for data; and
receiving, from the controller in communication with the storage in the storage medium, the data.

19. The non-transitory computer-readable medium of claim 18, wherein the controller performs wear leveling, command queueing, and error correction.

20. The non-transitory computer-readable medium of claim 18, wherein the byte addressable memory apertures comprises a fast serial protocol specific interface layer.
